(19) United States
(12) Patent Application Publication
(10) Pub. No.: US 2025/0111070 A1
(43) Pub. Date: Apr. 3, 2025

(54) AUTHORIZATION ON USER DEFINED ENTITY TYPES

(71) Applicant: Snowflake Inc., Bozeman, MT (US)

(72) Inventors: Damien Carru, New York, NY (US); Eric Karlson, Alameda, CA (US); Haojie Luan, Bellevue, WA (US); Mohamad Raja Gani Mohamad Abdul, Fremont, CA (US); Frantisek Rolinek, Seattle, WA (US)

(21) Appl. No.: 18/375,252

(22) Filed: Sep. 29, 2023

(51) Int. Cl. G06F 21/62; G06F 21/60

(52) U.S. Cl. CPC G06F 21/6218; G06F 21/604

(57) ABSTRACT

Disclosed are techniques for providing scoped grants that provide object-specific authorization for privileges on user-defined objects. A scoped grant is a grant of a generalized, non-specific privilege that also limits the contexts in which that grant is applicable (i.e., scopes the grant) during authorization, where the “context” is defined by the user-defined object upon which the privilege is being performed. A user statement requesting a grant of a privilege on a user-defined object may be received. A scoped privilege that provides a grant of a base privilege identified from the user statement and limits application of the grant of the base privilege to the user-defined object is created. Scoping object information associated with the user-defined object is provided to an authorization engine, wherein the scoping information includes a set of properties identifying the user-defined object. A scoped grant is created based on the scoped privilege using the scoping object information.

### TECHNICAL FIELD

The present disclosure relates to data sharing platforms, and particularly to using secure roles to manage role hierarchies and assignment of permissions in a role-based access control (RBAC) framework.

### BACKGROUND

Databases are widely used for data storage and access in computing applications. Databases may include one or more tables that include or reference data that can be read, modified, or deleted using queries. Databases may be used for storing and/or accessing personal information or other sensitive information. Secure storage and access of database data may be provided by encrypting and/or storing data in an encrypted form to prevent unauthorized access. In some cases, data sharing may be desirable to let other parties perform queries against a set of data.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A is a block diagram depicting an example computing environment in which the methods disclosed herein may be implemented, in accordance with some embodiments of the present invention.

FIG. 1B is a block diagram illustrating an example virtual warehouse, in accordance with some embodiments of the present invention.

FIG. 2 is a schematic block diagram of data that may be used to implement a public or private data exchange, in accordance with some embodiments of the present invention.

FIG. 3A is a schematic block diagram of a cloud deployment, in accordance with some embodiments of the present invention.

FIG. 3B is a schematic block diagram of a cloud deployment implementing techniques for providing object-specific authorization for privileges on user-defined objects using scoped grants, in accordance with some embodiments of the present invention.

FIG. 4 is a diagram illustrating metadata storage slices dedicated to scoped grant metadata, in accordance with some embodiments of the present invention.

FIG. 5 is a schematic block diagram of a cloud deployment implementing techniques for providing object-specific authorization for privileges on user-defined objects using scoped grants, in accordance with some embodiments of the present invention.

FIG. 6 is a flow diagram of a method for providing object-specific authorization for privileges on user-defined objects using scoped grants, in accordance with some embodiments of the present invention.

FIG. 7 is a block diagram of an example computing device that may perform one or more of the operations described herein, in accordance with some embodiments of the present invention.

### DETAILED DESCRIPTION

Data providers often have data assets that are cumbersome to share. A data asset may be data that is of interest to another entity. For example, a large online retail company may have a data set that includes the purchasing habits of millions of consumers over the last ten years. This data set may be large. If the online retailer wishes to share all or a portion of this data with another entity, the online retailer may need to use old and slow methods to transfer the data, such as a file-transfer-protocol (FTP), or even copying the data onto physical media and mailing the physical media to the other entity. This has several disadvantages. First, it is slow as copying terabytes or petabytes of data can take days. Second, once the data is delivered, the provider cannot control what happens to the data. The recipient can alter the data, make copies, or share it with other parties. Third, the only entities that would be interested in accessing such a large data set in such a manner are large corporations that can afford the complex logistics of transferring and processing the data as well as the high price of such a cumbersome data transfer. Thus, smaller entities (e.g., “mom and pop” shops) or even smaller, more nimble cloud-focused startups are often priced out of accessing this data, even though the data may be valuable to their businesses. This may be because raw data assets are generally too unpolished and full of potentially sensitive data to simply outright sell/provide to other companies. Data cleaning, de-identification, aggregation, joining, and other forms of data enrichment need to be performed by the owner of data before it is shareable with another party. This is time-consuming and expensive. Finally, it is difficult to share data assets with many entities because traditional data sharing methods do not allow scalable sharing for the reasons mentioned above. Traditional sharing methods also introduce latency and delays in terms of all parties having access to the most recently-updated data.

Private and public data exchanges may allow data providers to more easily and securely share their data assets with other entities. A public data exchange (also referred to herein as a “Snowflake data marketplace,” or a “data marketplace”) may provide a centralized repository with open access where a data provider may publish and control live and read-only data sets to thousands of consumers. A private data exchange (also referred to herein as a “data exchange”) may be under the data provider's brand, and the data provider may control who can gain access to it. The data exchange may be for internal use only, or may also be opened to consumers, partners, suppliers, or others. The data provider may control what data assets are listed as well as control who has access to which sets of data. This allows for a seamless way to discover and share data both within a data provider's organization and with its business partners.

The data exchange may be facilitated by a cloud computing service such as SNOWFLAKE™, and allows data providers to offer data assets directly from their own online domain (e.g., website) in a private online marketplace with their own branding. The data exchange may provide a centralized, managed hub for an entity to list internally or externally-shared data assets, inspire data collaboration, and also to maintain data governance and to audit access. With the data exchange, data providers may be able to share data without copying it between companies. Data providers may invite other entities to view their data listings, control which data listings appear in their private online marketplace, control who can access data listings and how others can interact with the data assets connected to the listings. This may be thought of as a “walled garden” marketplace, in which visitors to the garden must be approved and access to certain listings may be limited.

As an example, Company A may be a consumer data company that has collected and analyzed the consumption habits of millions of individuals in several different categories. Their data sets may include data in the following categories: online shopping, video streaming, electricity consumption, automobile usage, internet usage, clothing purchases, mobile application purchases, club memberships, and online subscription services. Company A may desire to offer these data sets (or subsets or derived products of these data sets) to other entities. For example, a new clothing brand may wish to access data sets related to consumer clothing purchases and online shopping habits. Company A may support a page on its website that is or functions substantially similar to a data exchange, where a data consumer (e.g., the new clothing brand) may browse, explore, discover, access and potentially purchase data sets directly from Company A. Further, Company A may control: who can enter the data exchange, the entities that may view a particular listing, the actions that an entity may take with respect to a listing (e.g., view only), and any other suitable action. In addition, a data provider may combine its own data with other data sets from, e.g., a public data exchange (also referred to as a “Snowflake data marketplace,” or a “data marketplace”), and create new listings using the combined data.

A data exchange may be an appropriate place to discover, assemble, clean, and enrich data to make it more monetizable. A large company on a data exchange may assemble data from across its divisions and departments, which could become valuable to another company. In addition, participants in a private ecosystem data exchange may work together to join their datasets together to jointly create a useful data product that any one of them alone would not be able to produce. Once these joined datasets are created, they may be listed on the data exchange or on the data marketplace.

Containers such as databases and schemas may be used to organize data stored in a data exchange and each database may belong to a single account within the data exchange. Each database may be thought of as a container having a classic folder hierarchy within it. Each database may be a logical grouping of schemas and a schema may be a logical grouping of database objects (tables, views, etc.). Each schema may belong to a single database.

Sharing data may be performed when a data provider creates a share object (hereinafter referred to as a share) of a database in the data provider's account and grants the share access to particular objects (e.g., tables, secure views, and secure user-defined functions (UDFs)) of the database. Then, a read-only database may be created using information provided in the share. Access to this database may be controlled by the data provider. A “share” encapsulates all of the information required to share data in a database. A share may include at least three pieces of information: (1) privileges that grant access to the database(s) and the schema containing the objects to share, (2) the privileges that grant access to the specific objects (e.g., tables, secure views, and secure UDFs), and (3) the consumer accounts with which the database and its objects are shared. The consumer accounts with which the database and its objects are shared may be indicated by a list of references to those consumer accounts contained within the share object. Only those consumer accounts that are specifically listed in the share object may be allowed to look up, access, and/or import from this share object. By modifying the list of references of other consumer accounts, the share object can be made accessible to more accounts or be restricted to fewer accounts.

In some embodiments, each share object contains a single role. Grants between this role and objects define what objects are being shared and with what privileges these objects are shared. The role and grants may be similar to any other role and grant system in the implementation of role-based access control. By modifying the set of grants attached to the role in a share object, more objects may be shared (by adding grants to the role), fewer objects may be shared (by revoking grants from the role), or objects may be shared with different privileges (by changing the type of grant, for example to allow write access to a shared table object that was previously read-only). In some embodiments, share objects in a provider account may be imported into the target consumer account using alias objects and cross-account role grants.

When data is shared, no data is copied or transferred between users. Sharing is accomplished through the cloud computing services of a cloud computing service provider such as SNOWFLAKE™. Shared data may then be used to process SQL queries, possibly including joins, aggregations, or other analysis. In some instances, a data provider may define a share such that “secure joins” are permitted to be performed with respect to the shared data. A secure join may be performed such that analysis may be performed with respect to shared data but the actual shared data is not accessible by the data consumer (e.g., recipient of the share).

A data exchange may also implement role-based access control (RBAC) to govern access to objects within consumer accounts using account level roles and grants. Account level roles are special objects in a consumer account that are assigned to users, and grants between an account level role and database objects define what privileges the account level role has on these objects. The account level roles of a user include a special role called e.g., “PUBLIC” which every user is granted, and some number of additional user-created roles. For example, a role that has a usage grant on a database can “see” the database when executing the command “show databases,” while a role that has a select grant on a table can read from the table but not write to the table. The role would need to have a modify grant on the table to be able to write to it. These roles exist in a hierarchy where certain roles dominate others. Granting one role to another role creates the role hierarchy and determines which roles dominate which other roles (e.g., a first role dominates a second role that is granted to it). A permission may comprise a privilege which applies to an object, such as SELECT (privilege) on a particular TABLE (object). Permissions are granted to roles and every role inherits all permissions granted directly to itself and those granted to any role that it (recursively) dominates.

A data exchange may allow users to define object types that have the same status as built-in object types such as tables, views, etc. Examples of such user-defined object types include bundle classes and tags. The data exchange may provide a generalized built-in privilege that allows a user to create an instance of any user-defined object type. For built-in object types such as tables and schemas, the privilege authorization model is hard coded in a query engine of the data exchange so that it can support the grant of privileges on objects of those types without. However, it is difficult to provide a built-in/hard-coded privilege authorization model for user-defined objects because the query engine has no way of knowing what the user-defined object is/how it will function. Therefore, a user cannot define an object and then manage privileges specific to the defined object.

Embodiments of the present disclosure address the above noted and other problems by providing scoped grants that provide object-specific authorization for privileges such as CREATE and APPLY on user-defined objects. A scoped grant is a grant of a generalized, non-specific privilege that also limits the contexts in which that grant is applicable (i.e., scopes the grant) during authorization, where the “context” is defined (or scoped) by the user-defined object upon which the privilege is being performed. In this way, embodiments of the present disclosure solve the problem of how to effectively define authorization checks that are specific to arbitrary user-defined objects. The techniques described herein allow for selective filtering of generalized grants that should be applied only in certain contexts, where the “context” is defined by the user-defined object upon which an operation is being performed.

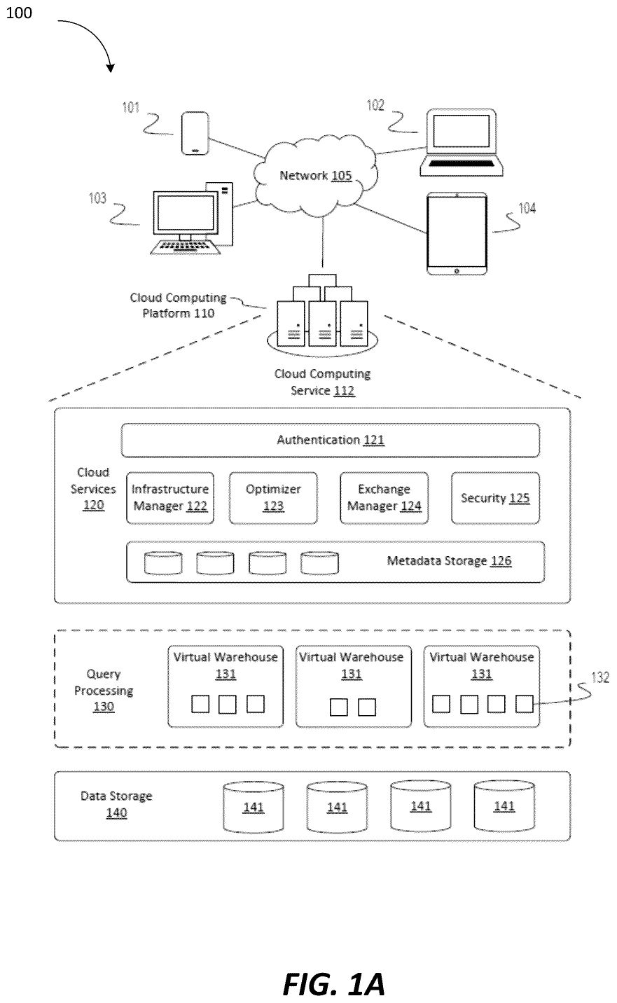

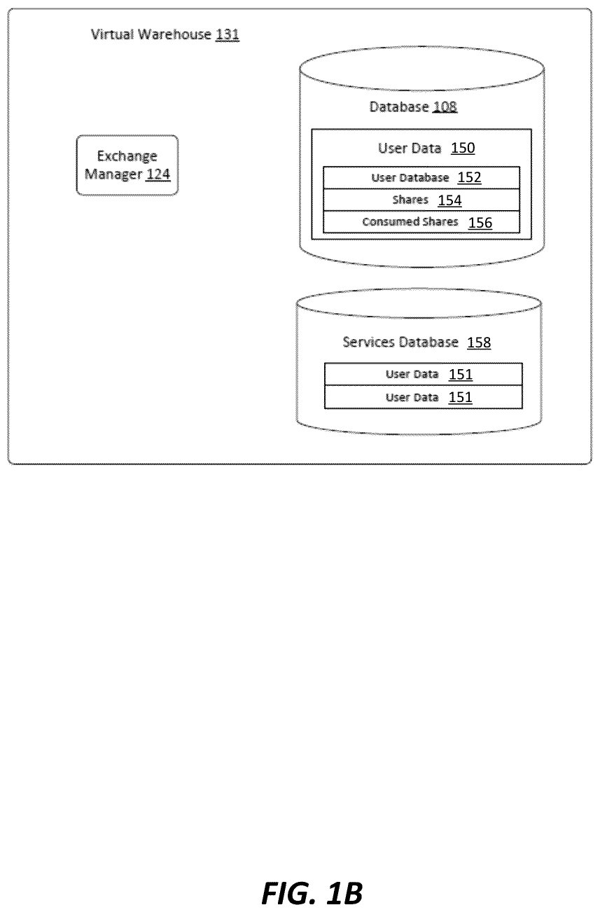

FIG. 1A is a block diagram of an example computing environment 100 in which the systems and methods disclosed herein may be implemented. In particular, a cloud computing platform 110 may be implemented, such as Amazon Web Services™ (AWS), Microsoft Azure™, Google Cloud™, or the like. As known in the art, a cloud computing platform 110 provides computing resources and storage resources that may be acquired (purchased) or leased and configured to execute applications and store data.

The cloud computing platform 110 may host a cloud computing service 112 that facilitates storage of data on the cloud computing platform 110 (e.g., data management and access) and analysis functions (e.g., SQL queries, analysis), as well as other computation capabilities (e.g., secure data sharing between users of the cloud computing platform 110). The cloud computing platform 110 may include a three-tier architecture: data storage 140, query processing 130, and cloud services 120.

Data storage 140 may facilitate the storing of data on the cloud computing platform 110 in one or more cloud databases 141. Data storage 140 may use a storage service such as Amazon S3™ to store data and query results on the cloud computing platform 110. In particular embodiments, to load data into the cloud computing platform 110, data tables may be horizontally partitioned into large, immutable files which may be analogous to blocks or pages in a traditional database system. Within each file, the values of each attribute or column are grouped together and compressed using a scheme sometimes referred to as hybrid columnar. Each table has a header which, among other metadata, contains the offsets of each column within the file.

In addition to storing table data, data storage 140 facilitates the storage of temp data generated by query operations (e.g., joins), as well as the data contained in large query results. This may allow the system to compute large queries without out-of-memory or out-of-disk errors. Storing query results this way may simplify query processing as it removes the need for server-side cursors found in traditional database systems.

Query processing 130 may handle query execution within elastic clusters of virtual machines, referred to herein as virtual warehouses or data warehouses. Thus, query processing 130 may include one or more virtual warehouses 131, which may also be referred to herein as data warehouses. The virtual warehouses 131 may be one or more virtual machines operating on the cloud computing platform 110. The virtual warehouses 131 may be compute resources that may be created, destroyed, or resized at any point, on demand. This functionality may create an “elastic” virtual warehouse that expands, contracts, or shuts down according to the user's needs. Expanding a virtual warehouse involves generating one or more compute nodes 132 to a virtual warehouse 131. Contracting a virtual warehouse involves removing one or more compute nodes 132 from a virtual warehouse 131. More compute nodes 132 may lead to faster compute times. For example, a data load which takes fifteen hours on a system with four nodes might take only two hours with thirty-two nodes.

Cloud services 120 may be a collection of services that coordinate activities across the cloud computing service 112. These services tie together all of the different components of the cloud computing service 112 in order to process user requests, from login to query dispatch. Cloud services 120 may operate on compute instances provisioned by the cloud computing service 112 from the cloud computing platform 110. Cloud services 120 may include a collection of services that manage virtual warehouses, queries, transactions, data exchanges, and the metadata associated with such services, such as database schemas, access control information, encryption keys, and usage statistics. Cloud services 120 may include, but not be limited to, authentication engine 121, infrastructure manager 122, optimizer 123, exchange manager 124, security engine 125, and metadata storage 126.

FIG. 1B is a block diagram illustrating an example virtual warehouse 131. The exchange manager 124 may facilitate the sharing of data between data providers and data consumers, using, for example, a data exchange. For example, cloud computing service 112 may manage the storage and access of a database 108. The database 108 may include various instances of user data 150 for different users, e.g., different enterprises or individuals. The user data 150 may include a user database 152 of data stored and accessed by that user. The user database 152 may be subject to access controls such that only the owner of the data is allowed to change and access the user database 152 upon authenticating with the cloud computing service 112. For example, data may be encrypted such that it can only be decrypted using decryption information possessed by the owner of the data. Using the exchange manager 124, specific data from a user database 152 that is subject to these access controls may be shared with other users in a controlled manner. In particular, a user may specify shares 154 that may be shared in a public or data exchange in an uncontrolled manner or shared with specific other users in a controlled manner as described above. A “share” encapsulates all of the information required to share data in a database. A share may include at least three pieces of information: (1) privileges that grant access to the database(s) and the schema containing the objects to share, (2) the privileges that grant access to the specific objects (e.g., tables, secure views, and secure UDFs), and (3) the consumer accounts with which the database and its objects are shared. When data is shared, no data is copied or transferred between users. Sharing is accomplished through the cloud services 120 of cloud computing service 112.

Sharing data may be performed when a data provider creates a share of a database in the data provider's account and grants access to particular objects (e.g., tables, secure views, and secure user-defined functions (UDFs)). Then a read-only database may be created using information provided in the share. Access to this database may be controlled by the data provider.

Shared data may then be used to process SQL queries, possibly including joins, aggregations, or other analysis. In some instances, a data provider may define a share such that “secure joins” are permitted to be performed with respect to the shared data. A secure join may be performed such that analysis may be performed with respect to shared data but the actual shared data is not accessible by the data consumer (e.g., recipient of the share). A secure join may be performed as described in U.S. application Ser. No. 16/368,339, filed Mar. 18, 2019.

User devices 101-104, such as laptop computers, desktop computers, mobile phones, tablet computers, cloud-hosted computers, cloud-hosted serverless processes, or other computing processes or devices may be used to access the virtual warehouse 131 or cloud service 120 by way of a network 105, such as the Internet or a private network.

In the description below, actions are ascribed to users, particularly consumers and providers. Such actions shall be understood to be performed with respect to devices 101-104 operated by such users. For example, notification to a user may be understood to be a notification transmitted to devices 101-104, an input or instruction from a user may be understood to be received by way of the user's devices 101-104, and interaction with an interface by a user shall be understood to be interaction with the interface on the user's devices 101-104. In addition, database operations (joining, aggregating, analysis, etc.) ascribed to a user (consumer or provider) shall be understood to include performing of such actions by the cloud computing service 112 in response to an instruction from that user.

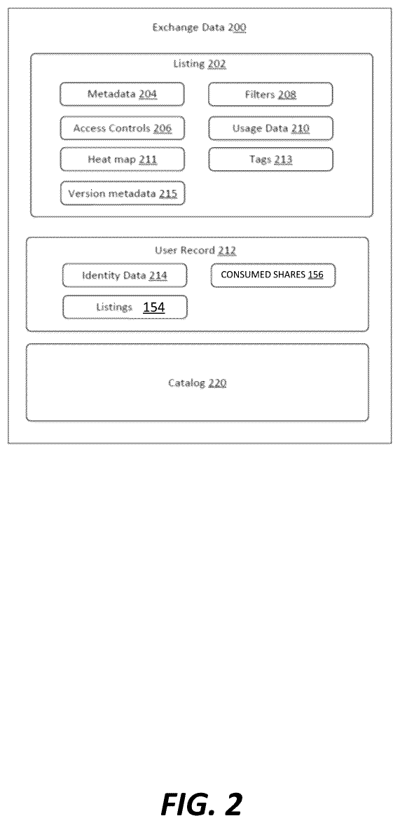

FIG. 2 is a schematic block diagram of data that may be used to implement a public or data exchange in accordance with an embodiment of the present invention. The exchange manager 124 may operate with respect to some or all of the illustrated exchange data 200, which may be stored on the platform executing the exchange manager 124 (e.g., the cloud computing platform 110) or at some other location. The exchange data 200 may include a plurality of listings 202 describing data that is shared by a first user (“the provider”). The listings 202 may be listings in a data exchange or in a data marketplace. The access controls, management, and governance of the listings may be similar for both a data marketplace and a data exchange.

The listing 202 may include access controls 206, which may be configurable to any suitable access configuration. For example, access controls 206 may indicate that the shared data is available to any member of the private exchange without restriction (an “any share” as used elsewhere herein). The access controls 206 may specify a class of users (members of a particular group or organization) that are allowed to access the data and/or see the listing. The access controls 206 may specify that a “point-to-point” share in which users may request access but are only allowed access upon approval of the provider. The access controls 206 may specify a set of user identifiers of users that are excluded from being able to access the data referenced by the listing 202.

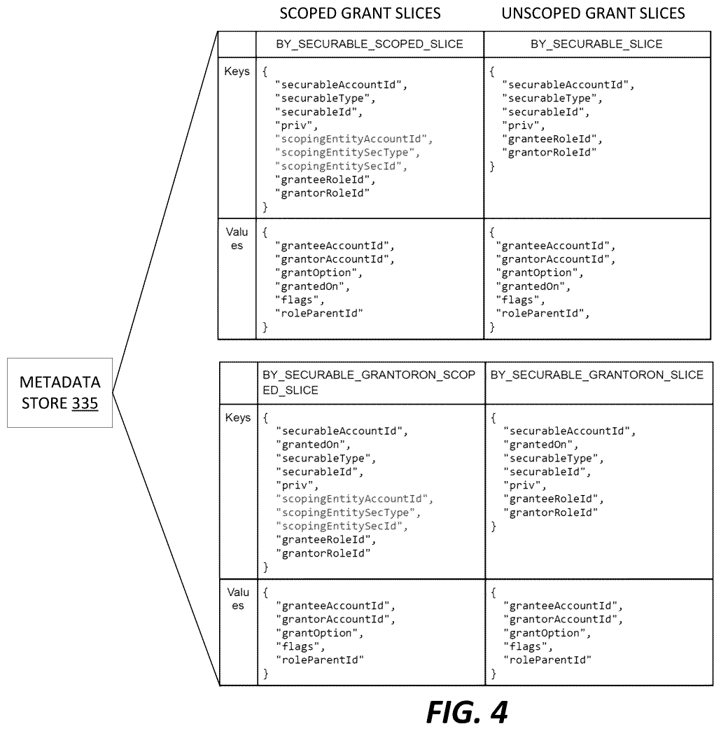

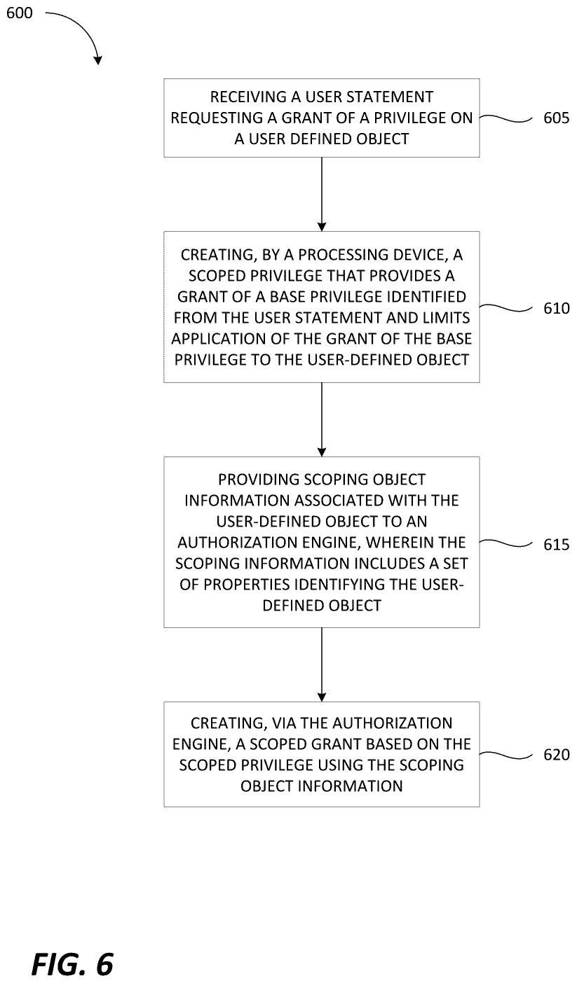

Note that some listings 202 may be discoverable by users without further authentication or access permissions whereas actual accesses are only permitted after a subsequent authentication step (see discussion of FIGS. 4 and 6). The access controls 206 may specify that a listing 202 is only discoverable by specific users or classes of users.

Note also that a default function for listings 202 is that the data referenced by the share is not exportable by the consumer. Alternatively, the access controls 206 may specify that this is not permitted. For example, access controls 206 may specify that secure operations (secure joins and secure functions as discussed below) may be performed with respect to the shared data such that viewing and exporting of the shared data is not permitted.

In some embodiments, once a user is authenticated with respect to a listing 202, a reference to that user (e.g., user identifier of the user's account with the virtual warehouse 131) is added to the access controls 206 such that the user will subsequently be able to access the data referenced by the listing 202 without further authentication.

The listing 202 may define one or more filters 208. For example, the filters 208 may define specific identity data 214 (also referred to herein as user identifiers) of users that may view references to the listing 202 when browsing the catalog 220. The filters 208 may define a class of users (users of a certain profession, users associated with a particular company or organization, users within a particular geographical area or country) that may view references to the listing 202 when browsing the catalog 220. In this manner, a private exchange may be implemented by the exchange manager 124 using the same components. In some embodiments, an excluded user that is excluded from accessing a listing 202, i.e., adding the listing 202 to the consumed shares 156 of the excluded user, may still be permitted to view a representation of the listing when browsing the catalog 220 and may further be permitted to request access to the listing 202 as discussed below. Requests to access a listing by such excluded users and other users may be listed in an interface presented to the provider of the listing 202. The provider of the listing 202 may then view demand for access to the listing and choose to expand the filters 208 to permit access to excluded users or classes of excluded users (e.g., users in excluded geographic regions or countries).

Filters 208 may further define what data may be viewed by a user. In particular, filters 208 may indicate that a user that selects a listing 202 to add to the consumed shares 156 of the user is permitted to access the data referenced by the listing but only a filtered version that only includes data associated with the identifier 214 of that user, associated with that user's organization, or specific to some other classification of the user. In some embodiments, a private exchange is by invitation: users invited by a provider to view listings 202 of a private exchange are enabled to do by the exchange manager 124 upon communicating acceptance of an invitation received from the provider.

In some embodiments, a listing 202 may be addressed to a single user. Accordingly, a reference to the listing 202 may be added to a set of “pending shares” that is viewable by the user. The listing 202 may then be added to a group of shares of the user upon the user communicating approval to the exchange manager 124.

The listing 202 may further include usage data 210. For example, the cloud computing service 112 may implement a credit system in which credits are purchased by a user and are consumed each time a user runs a query, stores data, or uses other services implemented by the cloud computing service 112. Accordingly, usage data 210 may record an amount of credits consumed by accessing the shared data. Usage data 210 may include other data such as a number of queries, a number of aggregations of each type of a plurality of types performed against the shared data, or other usage statistics. In some embodiments, usage data for a listing 202 or multiple listings 202 of a user is provided to the user in the form of a shared database, i.e., a reference to a database including the usage data is added by the exchange manager 124 to the consumed shares 156 of the user.

The listing 202 may also include a heat map 211, which may represent the geographical locations in which users have clicked on that particular listing. The cloud computing service 112 may use the heat map to make replication decisions or other decisions with the listing. For example, a data exchange may display a listing that contains weather data for Georgia, USA. The heat map 211 may indicate that many users in California are selecting the listing to learn more about the weather in Georgia. In view of this information, the cloud computing service 112 may replicate the listing and make it available in a database whose servers are physically located in the western United States, so that consumers in California may have access to the data. In some embodiments, an entity may store its data on servers located in the western United States. A particular listing may be very popular to consumers. The cloud computing service 112 may replicate that data and store it in servers located in the eastern United States, so that consumers in the Midwest and on the East Coast may also have access to that data.

The listing 202 may also include one or more tags 213. The tags 213 may facilitate simpler sharing of data contained in one or more listings. As an example, a large company may have a human resources (HR) listing containing HR data for its internal employees on a data exchange. The HR data may contain ten types of HR data (e.g., employee number, selected health insurance, current retirement plan, job title, etc.). The HR listing may be accessible to 100 people in the company (e.g., everyone in the HR department). Management of the HR department may wish to add an eleventh type of HR data (e.g., an employee stock option plan). Instead of manually adding this to the HR listing and granting each of the 100 people access to this new data, management may simply apply an HR tag to the new data set and that can be used to categorize the data as HR data, list it along with the HR listing, and grant access to the 100 people to view the new data set.

The listing 202 may also include version metadata 215. Version metadata 215 may provide a way to track how the datasets are changed. This may assist in ensuring that the data that is being viewed by one entity is not changed prematurely. For example, if a company has an original data set and then releases an updated version of that data set, the updates could interfere with another user's processing of that data set, because the update could have different formatting, new columns, and other changes that may be incompatible with the current processing mechanism of the recipient user. To remedy this, the cloud computing service 112 may track version updates using version metadata 215. The cloud computing service 112 may ensure that each data consumer accesses the same version of the data until they accept an updated version that will not interfere with current processing of the data set.

The exchange data 200 may further include user records 212. The user record 212 may include data identifying the user associated with the user record 212, e.g., an identifier (e.g., warehouse identifier) of a user having user data 151 in service database 158 and managed by the virtual warehouse 131.

The user record 212 may list shares associated with the user, e.g., reference listings 154 created by the user. The user record 212 may list shares consumed by the user, e.g., reference listings 202 created by another user and that have been associated to the account of the user according to the methods described herein. For example, a listing 202 may have an identifier that will be used to reference it in the shares or consumed shares 156 of a user record 212.

The listing 202 may also include metadata 204 describing the shared data. The metadata 204 may include some or all of the following information: an identifier of the provider of the shared data, a URL associated with the provider, a name of the share, a name of tables, a category to which the shared data belongs, an update frequency of the shared data, a catalog of the tables, a number of columns and a number of rows in each table, as well as name for the columns. The metadata 204 may also include examples to aid a user in using the data. Such examples may include sample tables that include a sample of rows and columns of an example table, example queries that may be run against the tables, example views of an example table, example visualizations (e.g., graphs, dashboards) based on a table's data. Other information included in the metadata 204 may be metadata for use by business intelligence tools, text description of data contained in the table, keywords associated with the table to facilitate searching, a link (e.g., URL) to documentation related to the shared data, and a refresh interval indicating how frequently the shared data is updated along with the date the data was last updated.

The metadata 204 may further include category information indicating a type of the data/service (e.g., location, weather), industry information indicating who uses the data/service (e.g., retail, life sciences), and use case information that indicates how the data/service is used (e.g., supply chain optimization, or risk analysis). For instance, retail consumers may use weather data for supply chain optimization.

The exchange data 200 may further include a catalog 220. The catalog 220 may include a listing of all available listings 202 and may include an index of data from the metadata 204 to facilitate browsing and searching according to the methods described herein. In some embodiments, listings 202 are stored in the catalog in the form of JavaScript Object Notation (JSON) objects.

Note that where there are multiple instances of the virtual warehouse 131 on different cloud computing platforms, the catalog 220 of one instance of the virtual warehouse 131 may store listings or references to listings from other instances on one or more other cloud computing platforms 110. Accordingly, each listing 202 may be globally unique (e.g., be assigned a globally unique identifier across all of the instances of the virtual warehouse 131). For example, the instances of the virtual warehouses 131 may synchronize their copies of the catalog 220 such that each copy indicates the listings 202 available from all instances of the virtual warehouse 131. In some instances, a provider of a listing 202 may specify that it is to be available on only specified one or more computing platforms 110.

In some embodiments, the catalog 220 is made available on the Internet such that it is searchable by a search engine such as the Bing™ search engine or the Google search engine. The catalog may be subject to a search engine optimization (SEO) algorithm to promote its visibility. Potential consumers may therefore browse the catalog 220 from any web browser. The exchange manager 124 may expose uniform resource locators (URLs) linked to each listing 202. This URL may be searchable and can be shared outside of any interface implemented by the exchange manager 124. For example, the provider of a listing 202 may publish the URLs for its listings 202 in order to promote usage of its listing 202 and its brand.

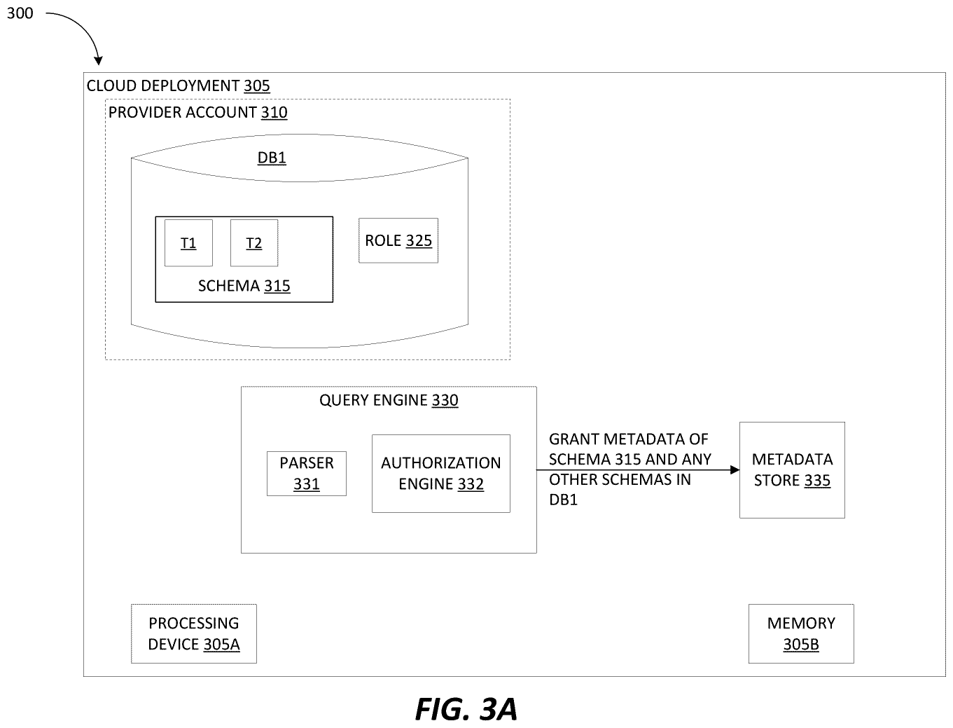

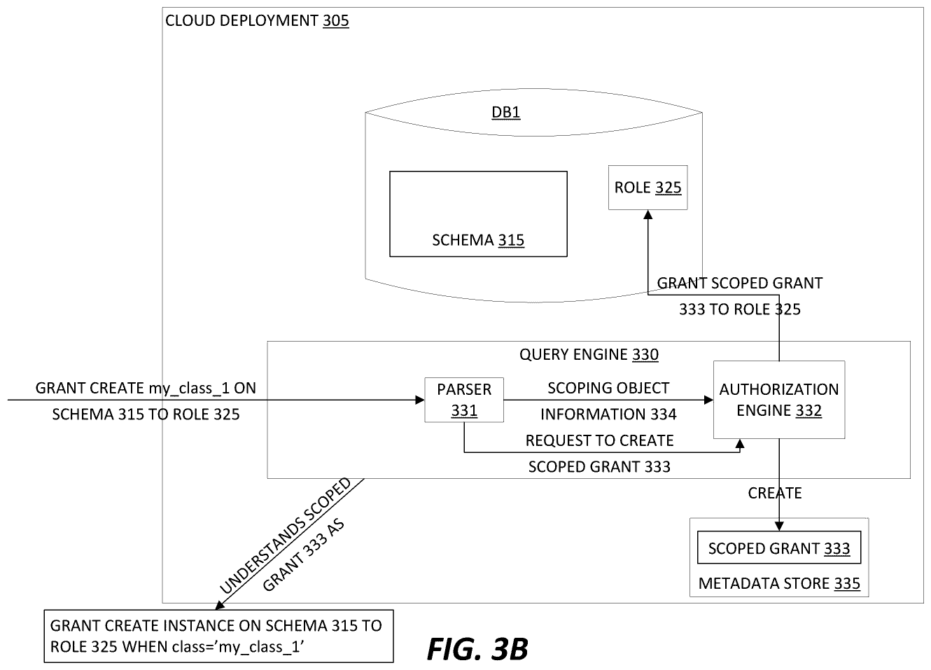

FIG. 3A illustrates a cloud environment 300 comprising a cloud deployment 305, which may comprise a similar architecture to cloud computing service 112 (illustrated in FIG. 1A) and may be a deployment of a data exchange or data marketplace. Although illustrated with a single cloud deployment, the cloud environment 300 may have multiple cloud deployments which may be physically located in separate remote geographical regions but may all be deployments of a single data exchange or data marketplace. The cloud deployment 305 may include hardware such as processing device 305A (e.g., processors, central processing units (CPUs), memory 305B (e.g., random access memory (RAM), storage devices (e.g., hard-disk drive (HDD), solid-state drive (SSD), etc.), and other hardware devices (e.g., sound card, video card, etc.). A storage device may comprise a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. The cloud deployment 305 may comprise any suitable type of computing device or machine that has a programmable processor including, for example, server computers, desktop computers, laptop computers, tablet computers, smartphones, set-top boxes, etc. In some examples, the cloud deployment 305 may comprise a single machine or may include multiple interconnected machines (e.g., multiple servers configured in a cluster).

Containers such as databases and schemas may be used to organize data stored in the cloud deployment 305 and each database may belong to a single account within the cloud deployment 305. Each database may be thought of as a container having a classic folder hierarchy within it. Each database may be a logical grouping of schemas and a schema may be a logical grouping of database objects (tables, views, etc.). Each schema may belong to a single database. In the example of FIG. 3A, the provider account 310 may include a database DB1, which includes a schema 315. The schema 315 may in turn include tables T1 and T2. The cloud deployment 305 may utilize any appropriate metadata store 335 such as FoundationDB, for example, to store the grant metadata of schema 315 and any other schemas within database DB1. FIG. 3A also illustrates a query engine 330, which may function to perform the query processing, object discovery, RBAC, and other functions of the cloud deployment 305 as discussed in further detail herein. The query engine 330 may comprise a parser 331 and an authorization engine 332. The parser 331 may analyze the structure of an SQL statement (also referred to herein as a “user statement”) and decompose it into its elements e.g., tables, columns, joins, filters, subqueries etc. When a user statement (e.g., a user statement granting a privilege) is received from the parser 331, the authorization engine 322 may consult a set of authorization rules to determine whether the currently active role has authorization to take the action specified in the user statement (e.g., create the grant). Although described herein with respect to user statements provided in SQL, embodiments of the present disclosure are not limited in this way and any appropriate query language may be used.

The cloud deployment 305 may allow users to define object types that have the same status as built-in object types such as tables, views, etc. Examples of such user-defined object types include bundle classes and tags. Thus, the cloud environment 300 may provide a generalized built-in privilege called CREATE INSTANCE which allows a user to create an instance of any bundle class. The following user statements provide an example:
CREATE CLASS my_class_1 . . . ;
CREATE CLASS my_class_2 . . . ;

### Grant Create Instance on Schema 315 to Role 325;

The above grant authorizes the creation of a bundle instance of any class within schema 315. A user could create instances of both the my_class_1 and my_class_2 classes in this manner. To authorize creation of an instance of only my_class_1, a user would ideally be able to do this by inputting the following user statement to the query engine 330:

### Grant Create My_Class_1 on Schema 315 to Role 325;

But since my_class_1 is an arbitrary, user-defined object, an authorization model for such a privilege cannot be hard-coded in the query engine 330. For built-in object types, the privilege authorization model is hard coded in the query engine 330 so that it can support the grant of privileges on objects of those types. However, a user cannot define an object and then manage privileges specific to the defined object because the query engine 330 has no way of knowing what the user-defined object is/how it will function. As a result, it is difficult to provide a built-in/hard-coded privilege authorization model for user-defined objects.

Embodiments of the present disclosure provide scoped grants that provide object-specific authorization for privileges such as CREATE and APPLY on user-defined objects. A scoped grant is a grant of a generalized, non-specific privilege that also limits the contexts in which that grant is applicable (i.e., scopes the grant) during authorization, where the context is defined by the user-defined object upon which the privilege is being performed. Thus, a scoped grant is applied to a given object, as opposed to all objects of a given type. Using the example user statement “GRANT CREATE my_class_1 ON SCHEMA 315 TO ROLE 325,” the query engine 330 may create a scoped grant that is a generalized grant of CREATE INSTANCE which is only applicable when the user is creating an instance of the “my_class_1” user-defined object as discussed in further detail hereinbelow.

In this way, embodiments of the present disclosure solve the problem of how to effectively define authorization checks that are specific to arbitrary user-defined objects. The techniques described herein allow for selective filtering of generalized grants that should be applied only in certain contexts, where the context is defined by the user-defined object upon which an operation is being performed.

Referring to FIG. 3B, a user can input the below user statement to the query engine 330:

### Grant Create My_Class_1 on Schema 315 to Role 325

Although the user statement is provided with the traditional syntax, the parser 331 includes a rule (not shown) to recognize user statements that have a scoped context. More specifically, the rule may instruct the parser 331 to identify user statements requesting a GRANT operation and having a reference to a user-defined object as having a scoped context and requiring a scoped grant to be created. The rule may also instruct the parser 331 to identify user statements requesting creation of an instance of a user-defined object as having a scoped context and requiring a scoped grant to be authorized. In the example user statement above, the rule may allow the parser 331 to recognize that since the user statement includes the GRANT operation accompanied by “CREATE my_class_1” (reference to a user-defined object), it will require a scoped grant 333 to be created.

To create the scoped grant 333, the parser 331 may utilize a new class referred to as a scoped privilege, which may be an in-memory representation of the base privilege identified in the user statement along with a scoping object. The parser 331 may use the prefix of the privilege specified by the user statement to identify the base privilege. The object name identified in the user statement may be used as the scoping object which will limit the application of the base privilege (i.e., limit the contexts in which the base privilege will apply). In the example user statement above, the parser 331 may use the prefix CREATE to determine CREATE INSTANCE as the base privilege and determine my_class_1 (i.e., the class name/object name) as the scoping object to create the scoped privilege which includes the general “CREATE INSTANCE” privilege that is scoped to apply only when creating an instance of the my_class_1 user-defined object.

The scoped privilege references the base privilege identified in the user statement as the root privilege. The root privilege determines the privilege code which is used to look up the static unscoped privilege in the grant record data persistence object (DPO) of the metadata store 335. In addition, the scoped privilege provides a number of additional properties to identify the scoping object including the type of the scoping object, the ID of the scoping object and the account ID of the scoping object.

Although the ID of the scoping object is used to identify the scoping object, two objects of different types can have the same numerical object ID. Thus, to properly identify the scoping object, the parser 331 may include the type of the scoping object as part of the scoped privilege. The account ID of the scoping object may also be used to properly identify the scoping object as well as perform other functions.

The parser 331 may also pass scoping object information 334 corresponding to the scoping object (my_class_1) to the authorization engine 332. The scoping object information 334 may include the properties for identifying my_class_1 discussed above including the type of my_class_1, the ID of my_class_1 and the account ID of my_class_1.

To pass the scoping object information 334 to the authorization engine 332, some embodiments of the present disclosure also introduce a new property called scoped entity reference on the object reference class. An object reference is a data structure that can be used to pass a literal (i.e., a fixed data value) as part of a user statement. The literal can be used e.g., to specify object values for the underlying object. Object references will resolve to their internal representation upon execution of the user statement that they are part of. The parser 331 may set the scoped entity reference on the object reference corresponding to the underlying object where the scoped privilege is to be utilized with the scoping object information, in order to propagate the scoping object information downstream to the authorization engine 332. In the example of FIG. 3B, the underlying object where the scoped privilege is to be utilized is the schema 315. Thus, the parser 331 may set the scoped entity reference on the schema 315 object reference with the scoping object information 334 to propagate the scoping object information 334 downstream to the authorization engine 332.

The use of the scoped entity reference property provides a consistent way to pass scoping object information to the authorization engine 332 regardless of the type of scoping entity (e.g., class, tag etc.) for which a scoped privilege is being defined. By the time the authorization engine 332 is called to authorize a user statement that references a user-defined object, all the related entities including the target entity, the target parent entity and the scoping object are available and can be used by the authorization engine 332 to search for or create/authorize the relevant scoped grants. When a user statement having a reference to a user-defined object is received, the authorization engine 332 will look for the scoped entity reference property and resolve the scoping object accordingly (i.e., my_class_1 in the example of FIG. 3B).

Continuing the example of FIG. 3B, after passing the scoping object information 334 to the authorization engine 332, the parser 331 may call the authorization engine 332 to request creation of the scoped grant 333 and provide the scoped privilege to the authorization engine 332. The authorization engine 332 may use the scoping object information 334 to create the scoped grant 333 by registering the scoped privilege in the grant record DPO (not shown) of the metadata store 335 and associating it with the scoping object information 334, thereby creating the scoped grant 333 (which is granted to role 325).

It should be noted that the scoped grant 333 is not directly visible to the end user, and so the end user can input a user statement using the more SQL-natural syntax of “GRANT CREATE my_class_1 ON SCHEMA 315 TO ROLE 325.” However, what the query engine 330 creates internally is a grant of the general “CREATE INSTANCE” privilege that is scoped to apply only when creating an instance of my_class_1. FIG. 3B illustrates an example of how the query engine 330 understands the scoped grant 333: “GRANT CREATE INSTANCE ON SCHEMA 315 TO ROLE 325 WHEN class=′my_class_1′.”

The grant record DPO of the metadata store 335 may include a set of slices for storing unscoped grant metadata, and embodiments of the present disclosure may provide a set of slices dedicated to scoped grant metadata (also referred to herein as a set of scoped grant slices). Each of the set of scoped grant slices may be similar to a corresponding slice for storing unscoped grant metadata but may be modified to include the relevant scoping object information including the type of the scoping object, the ID of the scoping object and the account ID of the scoping object. FIG. 4 illustrates examples of slices dedicated to scoped grant metadata compared to slices compared to slices dedicated to unscoped grant metadata. As can be seen, the type of the scoping object, the ID of the scoping object and the account ID of the scoping object are represented in FIG. 4 by scopeentitySecType, scopeentitySecId and scopeSecAccountId respectively.

The metadata store 335 may also include a slice (not shown) to handle dropping a scoping object. When a scoping object is dropped, the cloud deployment 305 may drop all scoped grants within the grant record DPO that were scoped using that scoping object as well. In the example of FIG. 3B, if the class my_class_1 is dropped, then scoped grant 333 along with any scoped grants on schema 315 that were scoped with my_class_1, are dropped by the cloud deployment 305.

The metadata of objects, grants etc. are stored as blobs of data in the metadata store 335 in various DPOs. For each DPO, slices can be defined that act as an index so that, given a certain set of keys, a particular DPO or range of DPOs can be located. Slices are exposed to the query engine 330, which is hardcoded to search for certain DPOs using particular keys. As a result, searching for DPOs requires the query engine 330 to have an understanding of internal details of how the data is organized within the metadata store 335, including what the slices are, what the keys are, which slices have which data etc. While this may be acceptable for built-in object types whose data is stored within the metadata store 335 in a set manner, for scoped grants this is problematic because the business logic of a user must know which slices have scoped grant data, and when such scoped grant data should be used. Indeed, it is undesirable to put the burden of figuring out which slices to query on users, and such functionality would ideally be abstracted away from users and handled by the query engine 330.

To address this, the query engine 330 may abstract the logic for managing DPOs that is included as part of the grant record data access object (DAO) (not shown). Instead of exposing the internal details discussed above, the grant record DAO instead provides a list of types of searches a user can do, what keys to use, what information will be found, and whether it relates to scoped/unscoped grants, and abstracts all of this information as a set of indexes that a user can choose from. More specifically, the grant record DAO may provide APIs for queries/searches that replaces the notion of a slice name with an index selector. The index selector indicates the search keys to use, an indication of a scoping object (if any) and a flag that indicates whether one wants scoped grants, unscoped grants or both. All the logic for figuring out which slice to query, how to construct the keys for queries to scoped vs unscoped grants, and whether the search requires traversing one slice or multiple slices is all handled by the grant record DAO.

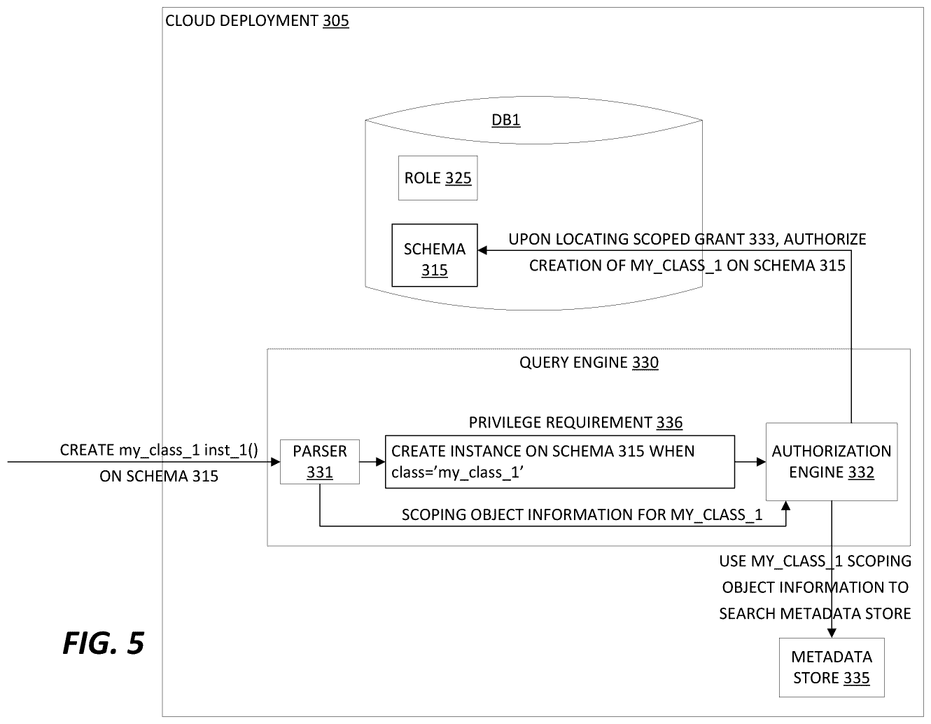

Referring to FIG. 5, upon receiving a subsequent user statement “CREATE my_class_1 inst_1 ( ) ON SCHEMA 315,” the parser 331 may determine that the subsequent user statement requests creation of an instance of a user-defined object and thus requires a scoped grant to be authorized. Thus, the parser 331 may identify the scoping object information of the user-defined object (e.g., the type of the scoping object, the ID of the scoping object and the account ID of the scoping object) and privilege requirements (i.e., what privileges must be held) to authorize the subsequent user statement and pass these to the authorization engine 332. The parser 331 may pass the scoping object information of the user-defined object using the scoped entity reference property as discussed hereinabove. The authorization engine 332 uses the supplied scoping information and the index selector to determine which grants are applicable (i.e., meet the privilege requirements) for the purpose of authorizing the subsequent user statement.

More specifically, the parser 331 may determine that the user wishes to create an instance of a class, and determine that the privilege requirement includes the CREATE INSTANCE on the schema 315 permission. The parser 331 may recognize that “CREATE my_class_1 inst_1 ( ) ON SCHEMA 315” is a scoped operation that is scoped by my_class_1 (user defined object) and further determine that the user specifically wishes to create an instance of my_class_1. The parser 331 may thus annotate the privilege requirement to indicate that the CREATE INSTANCE on the schema 315 permission is to be scoped by the “my_class_1” object (i.e., the CREATE INSTANCE on the schema 315 permission only applies when creating an instance of the “my_class_1” object) and pass the annotated privilege requirement 336 to the authorization engine 332 as shown in FIG. 5. FIG. 5 illustrates an example of the privilege requirement 336: “CREATE INSTANCE ON SCHEMA 315 TO ROLE 325 WHEN class=′my_class_1′.”

The authorization engine 332 may then use the supplied scoping object information to search the scoped grant slices of the metadata store 335 for grants of CREATE INSTANCE on the schema 315 where the scoping object is my_class_1, and will locate the scoped grant 333 (as discussed above) and authorize the subsequent user statement. In some embodiments, the authorization engine 332 may search scoped grant slices of the metadata store 335 for grants of CREATE INSTANCE on the schema 315 where the scoping object is my_class_1 and also search unscoped grant slices of the metadata store 335 for unscoped grants of CREATE INSTANCE on the schema 315. If a corresponding scoped or unscoped grant is found, the authorization engine 332 may pass the authorization check and authorize the subsequent user statement.

FIG. 6 is a flow diagram of a method 600 for providing object-specific authorization for privileges on user-defined objects using scoped grants, in accordance with some embodiments. Method 600 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 600 may be performed by a processing device of cloud deployment 305 (illustrated in FIGS. 3B and 5).

Referring simultaneously to FIG. 3B, at block 605, a user can input the below user statement to the query engine 330:

### Grant Create My_Class_1 on Schema 315 to Role 325

Although the user statement is provided with the traditional syntax, the parser 331 includes a rule (not shown) to recognize user statements that have a scoped context. More specifically, the rule may instruct the parser 331 to identify user statements requesting a GRANT operation and having a reference to a user-defined object as having a scoped context and requiring a scoped grant to be created. The rule may also instruct the parser 331 to identify user statements requesting creation of an instance of a user-defined object as having a scoped context and requiring a scoped grant to be authorized. In the example user statement above, the rule may allow the parser 331 to recognize that since the user statement includes the GRANT operation accompanied by “CREATE my_class_1” (reference to a user-defined object), it will require a scoped grant 333 to be created.

To create the scoped grant 333, at block 610 the parser 331 may utilize a new class referred to as a scoped privilege, which may be an in-memory representation of the base privilege identified in the user statement along with a scoping object. The parser 331 may use the prefix of the privilege specified by the user statement to identify the base privilege. The object name identified in the user statement may be used as the scoping object which will limit the application of the base privilege (i.e., limit the contexts in which the base privilege will apply). In the example user statement above, the parser 331 may use the prefix CREATE to determine CREATE INSTANCE as the base privilege and determine my_class_1 (i.e., the class name/object name) as the scoping object to create the scoped privilege which includes the general “CREATE INSTANCE” privilege that is scoped to apply only when creating an instance of the my_class_1 user-defined object.

The scoped privilege references the base privilege identified in the user statement as the root privilege. The root privilege determines the privilege code which is used to look up the static unscoped privilege in the grant record data persistence object (DPO) of the metadata store 335. In addition, the scoped privilege provides a number of additional properties to identify the scoping object including the type of the scoping object, the ID of the scoping object and the account ID of the scoping object.

Although the ID of the scoping object is used to identify the scoping object, two objects of different types can have the same numerical object ID. Thus, to properly identify the scoping object, the parser 331 may include the type of the scoping object as part of the scoped privilege. The account ID of the scoping object may also be used to properly identify the scoping object as well as perform other functions.

At block 615, the parser 331 may pass scoping object information 334 corresponding to the scoping object (my_class_1) to the authorization engine 332. The scoping object information 334 may include the properties for identifying my_class_1 discussed above including the type of my_class_1, the ID of my_class_1 and the account ID of my_class_1.

To pass the scoping object information 334 to the authorization engine 332, some embodiments of the present disclosure also introduce a new property called scoped entity reference on the object reference class. An object reference is a data structure that can be used to pass a literal (i.e., a fixed data value) as part of a user statement. The literal can be used e.g., to specify object values for the underlying object. Object references will resolve to their internal representation upon execution of the user statement that they are part of. The parser 331 may set the scoped entity reference on the object reference corresponding to the underlying object where the scoped privilege is to be utilized with the scoping object information, in order to propagate the scoping object information downstream to the authorization engine 332. In the example of FIG. 3B, the underlying object where the scoped privilege is to be utilized is the schema 315. Thus, the parser 331 may set the scoped entity reference on the schema 315 object reference with the scoping object information 334 to propagate the scoping object information 334 downstream to the authorization engine 332.

The use of the scoped entity reference property provides a consistent way to pass scoping object information to the authorization engine 332 regardless of the type of scoping entity (e.g., class, tag etc.) for which a scoped privilege is being defined. By the time the authorization engine 332 is called to authorize a user statement that references a user-defined object, all the related entities including the target entity, the target parent entity and the scoping object are available and can be used by the authorization engine 332 to search for or create/authorize the relevant scoped grants. When a user statement having a reference to a user-defined object is received, the authorization engine 332 will look for the scoped entity reference property and resolve the scoping object accordingly (i.e., my_class_1 in the example of FIG. 3B).

At block 620, after passing the scoping object information 334 to the authorization engine 332, the parser 331 may call the authorization engine 332 to request creation of the scoped grant 333 and provide the scoped privilege to the authorization engine 332. The authorization engine 332 may use the scoping object information 334 to create the scoped grant 333 by registering the scoped privilege in the grant record DPO (not shown) of the metadata store 335 and associating it with the scoping object information 334, thereby creating the scoped grant 333 (which is granted to role 325).

Referring also to FIG. 5, upon receiving a subsequent user statement “CREATE my_class_1 inst_1 ( ) ON SCHEMA 315,” the parser 331 may determine that the subsequent user statement requests creation of an instance of a user-defined object and thus requires a scoped grant to be authorized. Thus, the parser 331 may identify the scoping object information of the user-defined object (e.g., the type of the scoping object, the ID of the scoping object and the account ID of the scoping object) and privilege requirements (i.e., what privileges must be held) to authorize the subsequent user statement and pass these to the authorization engine 332. The parser 331 may pass the scoping object information of the user-defined object using the scoped entity reference property as discussed hereinabove. The authorization engine 332 uses the supplied scoping information and the index selector to determine which grants are applicable (i.e., meet the privilege requirements) for the purpose of authorizing the subsequent user statement.

More specifically, the parser 331 may determine that the user wishes to create an instance of a class, and determine that the privilege requirement includes the CREATE INSTANCE on the schema 315 permission. The parser 331 may recognize that “CREATE my_class_1 inst_1 ( ) ON SCHEMA 315” is a scoped operation that is scoped by my_class_1 (user-defined object) and further determine that the user specifically wishes to create an instance of my_class_1. The parser 331 may thus annotate the privilege requirement to indicate that the CREATE INSTANCE on the schema 315 permission is to be scoped by the “my_class_1” object (i.e., the CREATE INSTANCE on the schema 315 permission only applies when creating an instance of the “my_class_1” object) and pass the annotated privilege requirement 336 to the authorization engine 332 as shown in FIG. 5. FIG. 5 illustrates an example of the privilege requirement 336: “CREATE INSTANCE ON SCHEMA 315 TO ROLE 325 WHEN class=′my_class_1′.”

The authorization engine 332 may then use the supplied scoping object information to search the scoped grant slices of the metadata store 335 for grants of CREATE INSTANCE on the schema 315 where the scoping object is my_class_1, and will locate the scoped grant 333 (as discussed above) and authorize the subsequent user statement. In some embodiments, the authorization engine 332 may search scoped grant slices of the metadata store 335 for grants of CREATE INSTANCE on the schema 315 where the scoping object is my_class_1 and also search unscoped grant slices of the metadata store 335 for unscoped grants of CREATE INSTANCE. If a corresponding scoped or unscoped grant is found, the authorization engine 332 may pass the authorization check and authorize the subsequent user statement.

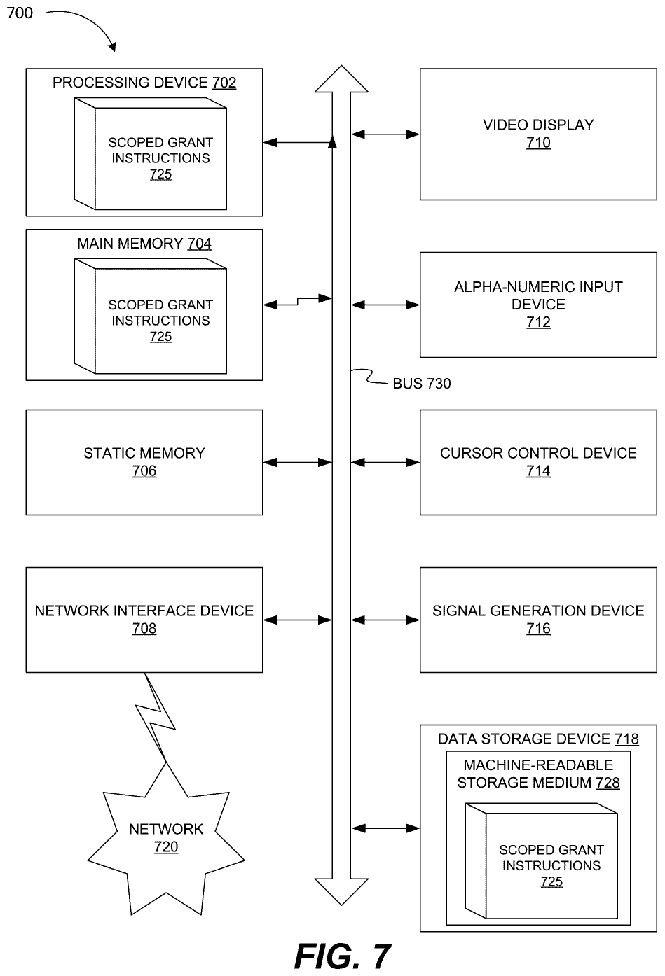

FIG. 7 illustrates a diagrammatic representation of a machine in the example form of a computer system 700 within which a set of instructions, for causing the machine to perform any one or more of the methodologies discussed herein for providing scoped grants that provide object-specific authorization for privileges such as CREATE and APPLY on user-defined objects.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 700 may be representative of a server.

The exemplary computer system 700 includes a processing device 702, a main memory 704 (e.g., read-only memory (ROM), flash memory, dynamic random access memory (DRAM), a static memory 706 (e.g., flash memory, static random access memory (SRAM), etc.), and a data storage device 718, which communicate with each other via a bus 730. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 700 may further include a network interface device 708 which may communicate with a network 720. The computing device 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and an acoustic signal generation device 716 (e.g., a speaker). In one embodiment, video display unit 710, alphanumeric input device 712, and cursor control device 714 may be combined into a single component or device (e.g., an LCD touch screen).

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute scoped grant instructions 725, for performing the operations and steps discussed herein.

The data storage device 718 may include a machine-readable storage medium 728, on which is stored one or more sets of scoped grant instructions 725 (e.g., software) embodying any one or more of the methodologies of functions described herein. The scoped grant instructions 725 may also reside, completely or at least partially, within the main memory 704 or within the processing device 702 during execution thereof by the computer system 700; the main memory 704 and the processing device 702 also constituting machine-readable storage media. The scoped grant instructions 725 may further be transmitted or received over a network 720 via the network interface device 708.

The machine-readable storage medium 728 may also be used to store instructions to perform a method for providing scoped grants that provide object-specific authorization for privileges such as CREATE and APPLY on user-defined objects, as described herein. While the machine-readable storage medium 728 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “receiving,” “routing,” “granting,” “determining,” “publishing,” “providing,” “designating,” “encoding,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned (including via virtualization) and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams or flow diagrams, and combinations of blocks in the block diagrams or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
receiving a user statement requesting a grant of a privilege on a user-defined object;
creating, by a processing device, a scoped privilege that provides a grant of a base privilege identified from the user statement and limits application of the grant of the base privilege to the user-defined object;
providing scoping object information associated with the user-defined object to an authorization engine, wherein the scoping information includes a set of properties identifying the user-defined object; and
creating, via the authorization engine, a scoped grant based on the scoped privilege using the scoping object information.

2. The method of claim 1, wherein creating the scoped privilege comprises:
identifying, from the user statement, the base privilege and a name of the user-defined object; and
generating an in-memory representation of the base privilege that is applicable only to an object instance having the name of the user-defined object.

3. The method of claim 2, wherein identifying the base privilege comprises:
identifying the base privilege based on a prefix of the privilege specified in the user statement.

4. The method of claim 1, wherein creating the scoped grant comprises:
storing the scoped privilege and the scoping object information in one or more slices of a metadata store that are dedicated to scoped grant metadata.

5. The method of claim 4, further comprising:
providing a set of APIs that implement an index selector to search the one or more slices for scoped grant metadata.

6. The method of claim 4, further comprising:
receiving a subsequent user statement requesting creation of an instance of the user-defined object;
determining a set of privilege requirements based on the subsequent user statement;
identifying from the subsequent user statement, second scoping information including a set of properties identifying the user-defined object;
passing the second scoping information and the set of privilege requirements to the authorization engine;
using the second scoping information to search the metadata store for grants that meet the privilege requirement; and
in response to determining that the scoped grant meets the privilege requirements, authorizing execution of the subsequent user statement.

7. The method of claim 1, wherein the user-defined object is a class.

8. A system comprising:
a memory; and
a processing device operatively coupled to the memory, the processing device to:
receive a user statement requesting a grant of a privilege on a user-defined object;
create a scoped privilege that provides a grant of a base privilege identified from the user statement and limits application of the grant of the base privilege to the user-defined object;
provide scoping object information associated with the user-defined object to an authorization engine, wherein the scoping information includes a set of properties identifying the user-defined object; and
create, via the authorization engine, a scoped grant based on the scoped privilege using the scoping object information.

9. The system of claim 8, wherein to create the scoped privilege, the processing device is to:
identify, from the user statement, the base privilege and a name of the user-defined object; and
generate an in-memory representation of the base privilege that is applicable only to an object instance having the name of the user-defined object.

10. The system of claim 9, wherein to identify the base privilege, the processing device is to: identify the base privilege based on a prefix of the privilege specified in the user statement.

11. The system of claim 8, wherein to create the scoped grant, the processing device is to:
store the scoped privilege and the scoping object information in one or more slices of a metadata store that are dedicated to scoped grant metadata.

12. The system of claim 11, wherein the processing device is further to:
provide a set of APIs that implement an index selector to search the one or more slices for scoped grant metadata.

13. The system of claim 11, wherein the processing device is further to:
receive a subsequent user statement requesting creation of an instance of the user-defined object;
determine a set of privilege requirements based on the subsequent user statement;
identify from the subsequent user statement, second scoping information including a set of properties identifying the user-defined object;
pass the second scoping information and the set of privilege requirements to the authorization engine;
use the second scoping information to search the metadata store for grants that meet the privilege requirement; and
in response to determining that the scoped grant meets the privilege requirements, authorize execution of the subsequent user statement.

14. The system of claim 8, wherein the user-defined object is a class.

15. A non-transitory computer-readable medium having instructions stored thereon which, when executed by a processing device, cause the processing device to:
receive a user statement requesting a grant of a privilege on a user-defined object;
create a scoped privilege that provides a grant of a base privilege identified from the user statement and limits application of the grant of the base privilege to the user-defined object;
provide scoping object information associated with the user-defined object to an authorization engine, wherein the scoping information includes a set of properties identifying the user-defined object; and
create, via the authorization engine, a scoped grant based on the scoped privilege using the scoping object information.

16. The non-transitory computer-readable medium of claim 15, wherein to create the scoped privilege, the processing device is to:
identify, from the user statement, the base privilege and a name of the user-defined object; and
generate an in-memory representation of the base privilege that is applicable only to an object instance having the name of the user-defined object.

17. The non-transitory computer-readable medium of claim 16, wherein to identify the base privilege, the processing device is to: identify the base privilege based on a prefix of the privilege specified in the user statement.

18. The non-transitory computer-readable medium of claim 15, wherein to create the scoped grant, the processing device is to:
store the scoped privilege and the scoping object information in one or more slices of a metadata store that are dedicated to scoped grant metadata.

19. The non-transitory computer-readable medium of claim 18, wherein the processing device is further to:
provide a set of APIs that implement an index selector to search the one or more slices for scoped grant metadata.

20. The non-transitory computer-readable medium of claim 18, wherein the processing device is further to:
receive a subsequent user statement requesting creation of an instance of the user-defined object;
determine a set of privilege requirements based on the subsequent user statement;
identify from the subsequent user statement, second scoping information including a set of properties identifying the user-defined object;
pass the second scoping information and the set of privilege requirements to the authorization engine;
use the second scoping information to search the metadata store for grants that meet the privilege requirement; and
in response to determining that the scoped grant meets the privilege requirements, authorize execution of the subsequent user statement.

21. The non-transitory computer-readable medium of claim 15, wherein the user-defined object is a class.
